(19) United States
(12) Patent Application Publication
(10) Pub. No.: US 2024/0324608 A1
(43) Pub. Date: Oct. 3, 2024

(54) Rotary Empanada Machine

(71) Applicant: Emma E. Mesa-Arias, Manizales (CO)

(72) Inventor: Emma E. Mesa-Arias, Manizales (CO)

(21) Appl. No.: 18/440,427

(22) Filed: Feb. 13, 2024

Related U.S. Application Data
(63) Continuation-in-part of application No. 18/129,127, filed on Mar. 31, 2023.

(51) Int. Cl. A21C 9/06

(52) U.S. Cl. CPC A21C 9/063

(57) ABSTRACT

The invention relates to a rotary machine for the production of empanadas, comprising up to six empanada holding stations within a rotating circular deck plate on which the empanadas are molded and folded through manual, electric and pneumatic motors and actuators. The invention includes changeable molds for folding and cutting the empanada dough, as well as disposable plastic sheets and wraps.

### CROSS-REFERENCE TO RELATED APPLICATIONS

This application is a continuation-in-part of pending U.S. Non-provisional patent application Ser. No. 18/129,127 titled “Automatic Rotary Empanada Machine”, filed on Mar. 31, 2023, the disclosure of which is herein incorporated by reference in its entirety.

### PATENTS CITED

The following documents and references are incorporated by reference in their entirety, Mesa-Escudero (U.S. Pat. No. 9,357,788 and U.S. Pat. Pub. No. 2016/0316768).

### FIELD OF THE INVENTION

The present invention relates to a system and method for a rotary empanada machine and to the production of empanadas.

### DESCRIPTION OF THE RELATED ART

Traditional turnovers (e.g. Empanadas, Arepas, Empanadillas, Pastelitos, Bolones, Papas rellenas, etc.) as well as processed vegetables (e.g. patacones, tostones, etc.) are baked or fried food items that are typically mechanically processed combinations of various edible parts. Turnovers are typically comprised of a wrapper or skin usually made of from one or various flours (including corn, wheat, cassava (aka Yuca), potato, rice, quinoa, oatmeal, plantain, banana, centeno, flax, etc.), wrapped around internal fillings made from one or more of beef, pork, chicken, cheese, grains, vegetables, etc., and seasoned with various spices. Processed veggies like patacones are made from pieces of vegetables like plantain, breadfruit, etc. that are pressed/molded into a desire shape.

While traditionally hand-made, more and more machines have been devised to facilitate all or parts of the preparation processing of turnovers and/or patacones. These processes include kneading the flour and then flattening with wooden or plastic rollers, before finally assembling them by flattening the dough and placing in the center a portion of the filling before covering the filling by typically folding the flattened dough. The ‘closing’ is typically accomplished by pressing them with your hand on their edges and then cutting the excess dough also with your hand or with a circular containers or molds. Manual manufacturing is for small productions because a lot of time is invested per unit.

For the production of empanadas on a large scale, various automated machines have been designed and manufactured, including those by MaquiEmpanadas covered in U.S. Pat. No. 9,357,788. However, in many situations, it is desired to automate only the most repetitive portions of the process while allowing the more efficient (and lower cost) manual operations to continue.

### SUMMARY OF THE INVENTION

This section is for the purpose of summarizing some aspects of the present invention and to briefly introduce some embodiments. Simplifications or omissions may be made to avoid obscuring the purpose of the section. Such simplifications or omissions are not intended to limit the scope of the present invention.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e., that it will be taken to mean an inclusion of not only the listed components it directly references, but also other non-specified components or elements. This rationale will also be used when the term ‘comprised’ or ‘comprising’ is used in relation to one or more steps in a method or process.

In one aspect, the invention is about an empanada manufacturing system comprising a support surface housing a circular rotatable turntable, vertical and horizontal support structures, turntable rotation control components, flattener and mold pressing activation components, control electronics and one or more user interface buttons, wherein said circular rotatable turntable has its surface area divided into at least four work areas, each said work area having a plastic sheet holder on its surface, a flattening mechanism mounted on said horizontal support structure above said turntable, said flattening mechanism occupying an area corresponding to one said turntable work area, a mold pressing mechanism mounted on said horizontal support structure above said turntable, said mold pressing mechanism occupying an area corresponding to one said turntable work area and automatic turntable rotation control components. In another aspect said turntable automatic rotation control component is comprised of a turntable brake component that automatically stops said turntable after one said work area advancement, electronic components allowing for the activation of the presser and the mold components after said work area advancement and said work area is covered by a foldable plastic sheet. In yet another aspect said turntable brake component is comprised of a spring actuated wheel under said turntable, said electronic components include an electronic switch coupled to said spring actuated wheel, said turntable lower surface has a cavity complementary to said spring actuated wheel under each said work area, said actuator for said presser is pneumatically activated and said actuator for said mold is pneumatically activated. In another aspect said presser is covered by a plastic cap.

In one aspect, the invention is about an empanada manufacturing method comprising providing a support surface housing a circular rotatable turntable, vertical and horizontal support structures, turntable rotation control components, flattener and mold pressing activation components, control electronics and one or more user interface buttons, wherein said circular rotatable turntable has its surface area divided into at least four work areas, each said work area having a plastic sheet holder on its surface, providing a flattening mechanism mounted on said horizontal support structure above said turntable, said flattening mechanism occupying an area corresponding to one said turntable work area, providing a mold pressing mechanism mounted on said horizontal support structure above said turntable, said mold pressing mechanism occupying an area corresponding to one said turntable work area and providing automatic turntable rotation control components. In another aspect said turntable automatic rotation control component is comprised of a turntable brake component that automatically stops said turntable after one said work area advancement, electronic components allowing for the activation of the presser and the mold components after said work area advancement and said work area is covered by a foldable plastic sheet. In yet another aspect, said turntable brake component is comprised of a spring actuated wheel under said turntable, said electronic components include an electronic switch coupled to said spring actuated wheel, said turntable lower surface has a cavity complementary to said spring actuated wheel under each said work area, said actuator for said presser is pneumatically activated and said actuator for said mold is pneumatically activated. In another aspect, said presser is covered by a plastic cap.

Other features and advantages of the present invention will become apparent upon examining the following detailed description of an embodiment thereof, taken in conjunction with the attached drawings, which are provided for purposes of illustration and not of limitation.

### BRIEF DESCRIPTION OF THE DRAWINGS

FIG. 1 shows a front perspective view of the rotary empanada machine, according to an exemplary embodiment of the invention.

FIG. 2 shows a back perspective view of the rotary empanada machine, according to an exemplary embodiment of the invention.

FIG. 3 shows a detailed perspective view of the empanada flattening portion of the rotary empanada machine, according to an exemplary embodiment of the invention.

FIG. 4 shows a perspective view of the flattening tool protective cap of the rotary empanada machine, according to an exemplary embodiment of the invention.

FIG. 5 shows a top view of the rotary platter of the rotary empanada machine, according to an exemplary embodiment of the invention.

FIG. 6 shows a perspective view of the folding plastic protector of the rotary empanada machine, according to an exemplary embodiment of the invention.

FIGS. 7 and 10 show perspective views of the rotary platter of the rotary empanada machine in action, according to an exemplary embodiment of the invention.

FIGS. 8 and 11 show perspectives view of the empanada mold and folding plastic protector interaction of the rotary empanada machine, according to an exemplary embodiment of the invention.

FIG. 9 shows a perspective view of a double empanada mold interaction with the rotary empanada machine, according to an exemplary embodiment of the invention.

FIG. 12 shows a perspective view of the rotation control components mounted on top of the unit's non-rotating based, according to an exemplary embodiment of the invention.

FIGS. 13-25 illustrate various views of the proposed molds, according to exemplary embodiments of the invention.

The above-described and other features will be appreciated and understood by those skilled in the art from the following detailed description and drawings.

### DETAILED DESCRIPTION OF THE INVENTION

To provide an overall understanding of the invention, certain illustrative embodiments and examples will now be described. However, it will be understood by one of ordinary skill in the art that the same or equivalent functions and sequences may be accomplished by different embodiments that are also intended to be encompassed within the spirit and scope of the disclosure. The compositions, apparatuses, systems and/or methods described herein may be adapted and modified as is appropriate for the application being addressed and that those described herein may be employed in other suitable applications, and that such other additions and modifications will not depart from the scope hereof.

As used in the specification and claims, the singular forms “a”, “an” and “the” include plural references unless the context clearly dictates otherwise. For example, the term “a transaction” may include a plurality of transaction unless the context clearly dictates otherwise. As used in the specification and claims, singular names or types referenced include variations within the family of said name unless the context clearly dictates otherwise.

Certain terminology is used in the following description for convenience only and is not limiting. The words “lower,” “upper,” “bottom,” “top,” “front,” “back,” “left,” “right” and “sides” designate directions in the drawings to which reference is made, but are not limiting with respect to the orientation in which the modules or any assembly of them may be used.

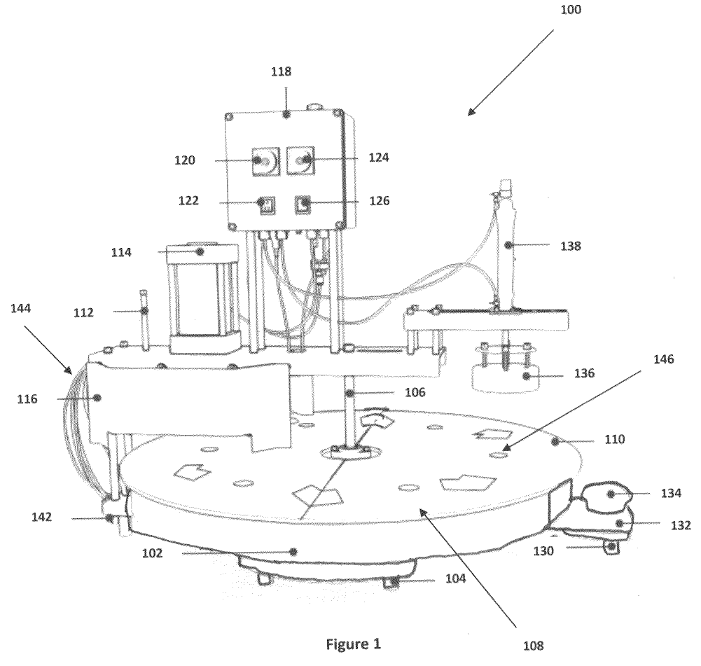

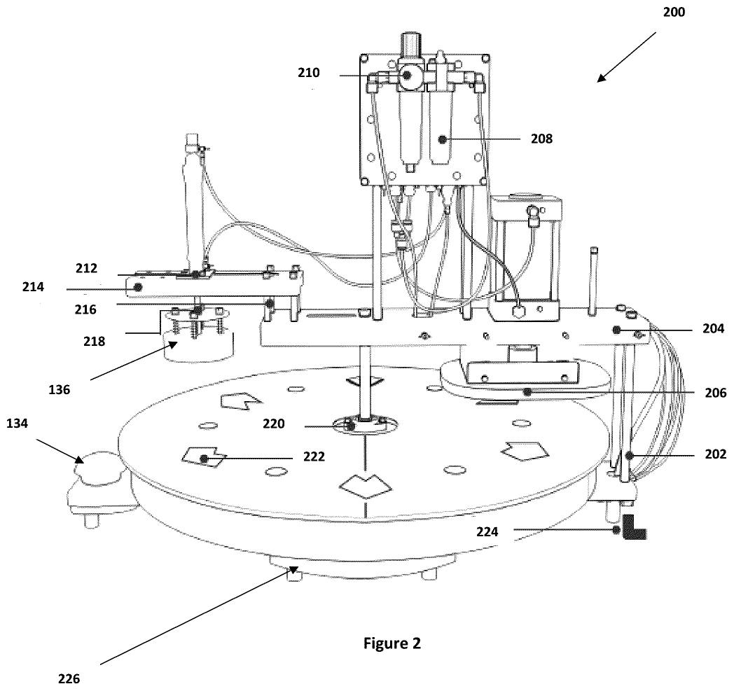

In one embodiment, referring to (FIGS. 1-2), we see a front view 100 and a back view 200 of the proposed rotary empanada machine comprised of a central rotatable platter or turntable 102 mounted on a central support 104 so that the turntable 102 rotates around a central axis, along which a central bar 106 protrudes. In one embodiment, said turntable 102 surface area is divided into four or more work stations or work areas 108, although there may be other number of work areas 108.

At a minimum, there is the need for a dough placement/removal work station, a dough flatting work station, a filling placement station and a mold pressing station. Additional ‘empty’ stations may be created so as to separate some of the above functions. The turntable 102 is comprised of two 110 acrylic halves as work surfaces or areas 108, although other plastic, metallic or composite surfaces may be used.

Above the turntable 102, an upper bridge 204 is supported between said central bar 106 and one or more lateral bars 202. On said bridge, a number of components are mounted. These include an anti-rotation bar 112, an upper cylinder 114, one or more security guards 116, an electronics control box 118. The control box 118 includes controls for the flattener 120, the automatic/manual rotation of the platter 122, Start-up button 124, control for the mold action 126. An additional security guard 116 is placed on the back to cover the actions of the flattener 206.

A lower bridge 130 holds a leveler 132 and a pulsating button 134 to allow turntable 102 advance. In one embodiment, the turntable 102 is braked in rotation after the width of one work areas 108, and pressing the button 134 allows for the rotation/advancement of one said station. In another embodiment, the turntable rotates one work area distance and is automatically braked when the wheel 1202 presses onto the one or more turntable lower surface opening(s) 1204, followed by the activation of the presser 206 and mold 136 (either automatically as the switch 1210 transitions, or as an operator presses the button 130 and the switch 1210 transitions. In another embodiment, the rotation and pressing is automatically accomplished by the control circuitry-based activation of a button or sensor. This rotation may be initiated via pneumatic pressure, or motorized or manual. To advance, the brake is released by pressing the button 134 and manually pushing the turntable 102 to rotate until the next work area 108 position advances. To facilitate centering the work area 108, an optional visible dot 146 may be used to indicate either the central area of the mold 136 or any other suitable position.

A cutting bridge 214 extends from the upper bridge 204, and supports the pressing/cutting mold 136 which extends/retracts through the actions of a small cylinder 138. Both the upper cylinder 114 and the small cylinder 138 operate off pneumatic lines 140 which couple at the base pneumatic connection 142, with pneumatic lines 144 distributing the air pressure. Note that in an alternate embodiment, the flatterer/mold 206/136 may be activated through electric motors.

In looking at the back view 200, we see further details of the exemplary embodiment. We see further components mounted on the electronics control box 118, which include a pneumatic pressure meter 210, an a pneumatic oil container 208. The cutting bridge 214 holds the piston 212, which extends the cylinder 216 that actuates the connector 218 holding the mold 136. A pneumatic compressor adapter 224 connects to the pneumatic connection 142. The complete assembly mounts onto any surface (table/counter/etc.) on a non-rotating base 226.

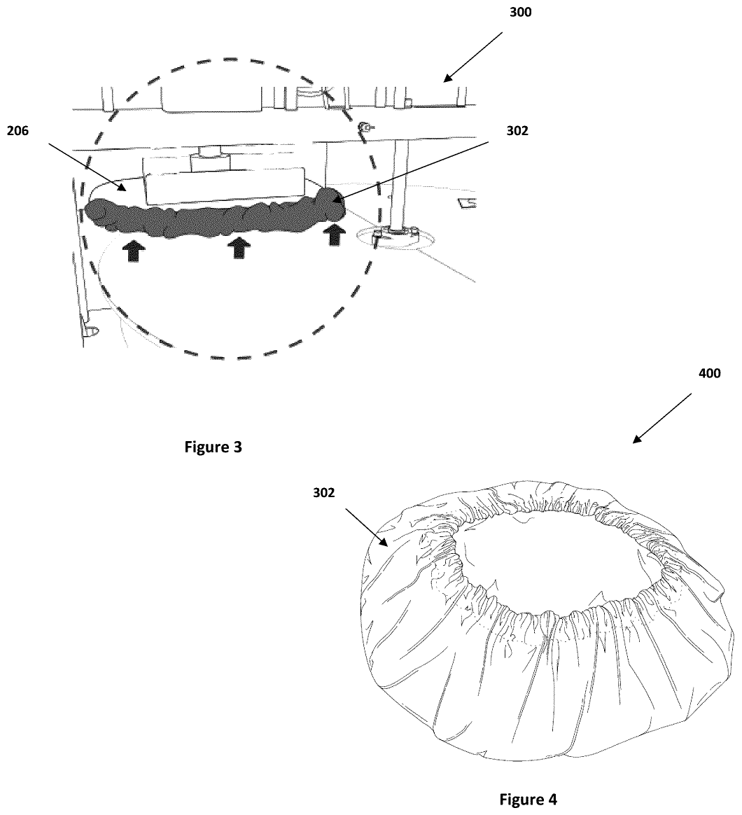

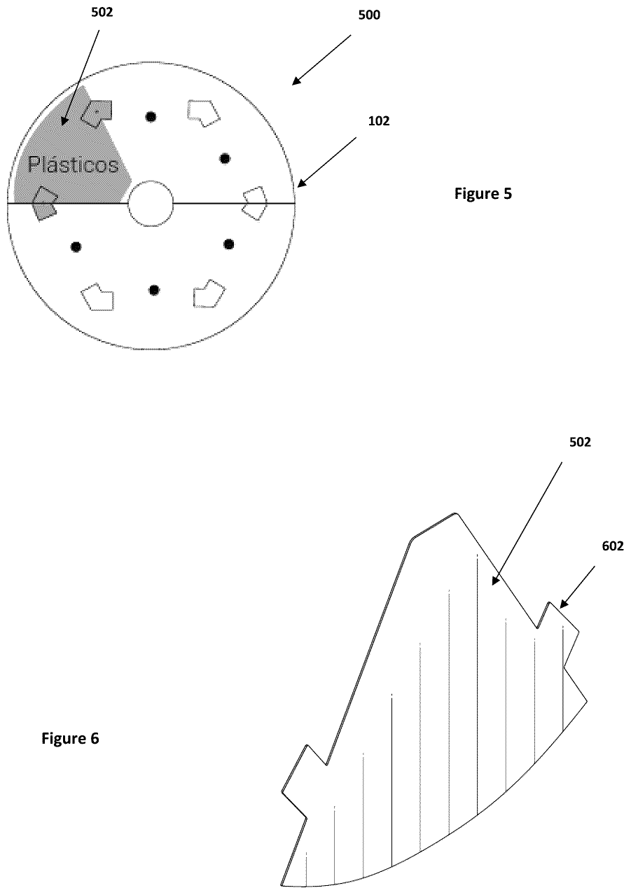

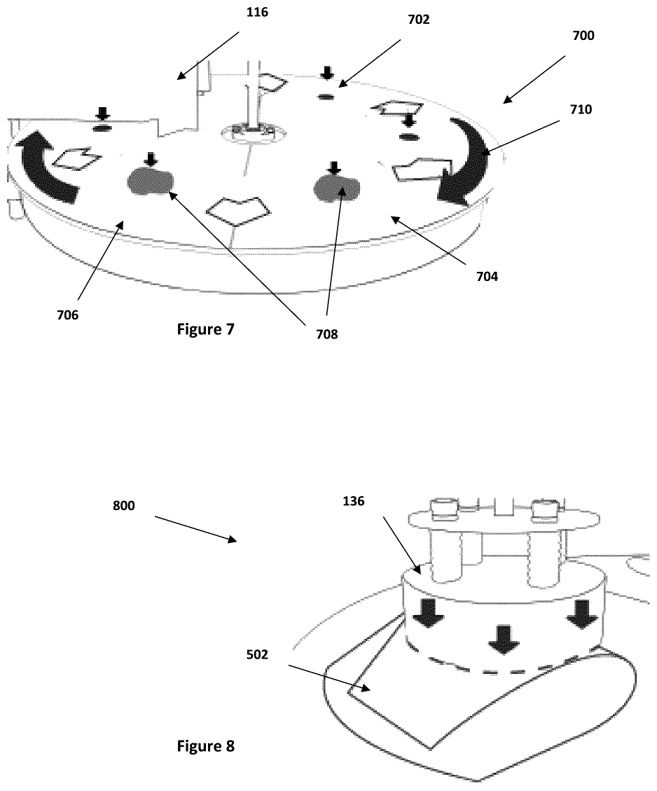

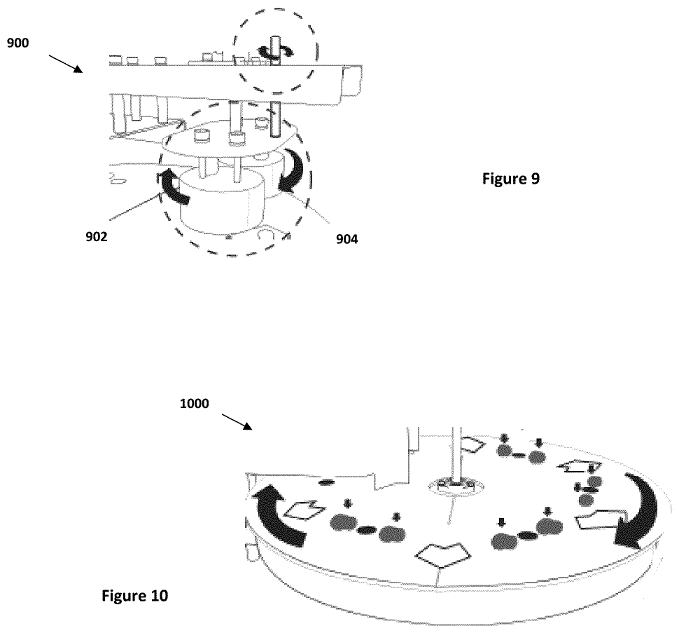

In one embodiment 300/400 (FIGS. 3-6), the dough flattener tool 206 is covered with a disposable plastic ‘cap’ 302, which tightly wraps around the flat portion of the flattener, allowing for health and easy cleaning. As seen in FIGS. 3, 5-6, the folding station 500 within the turntable 102. The turntable 102 centers on a rotating flange 220 around which the platter rotates. Each work areas 108 has a plastic sheet holder 222 designed to hold each edge 602 of the folding plastic sheet 502.

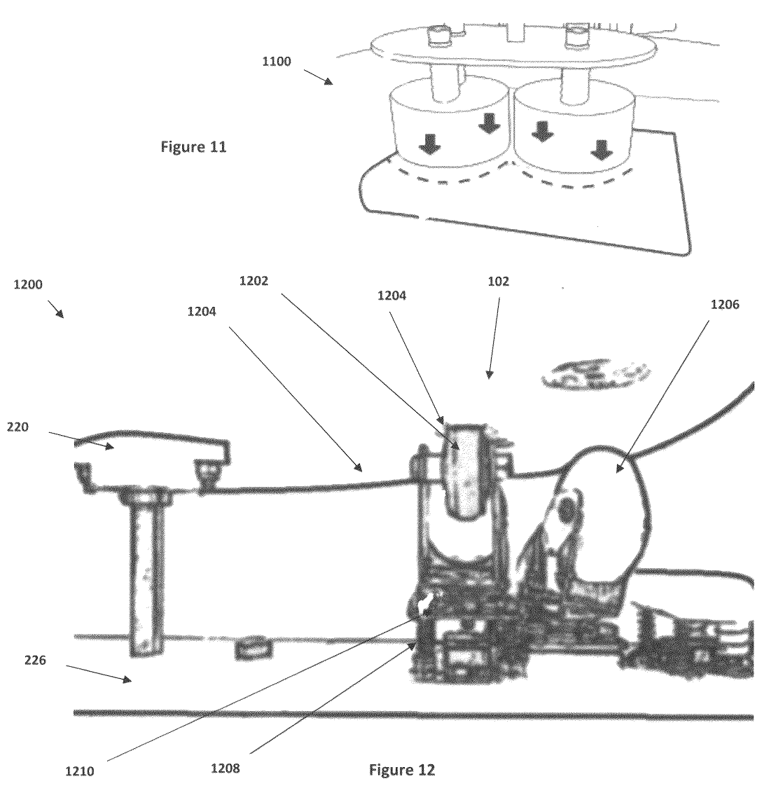

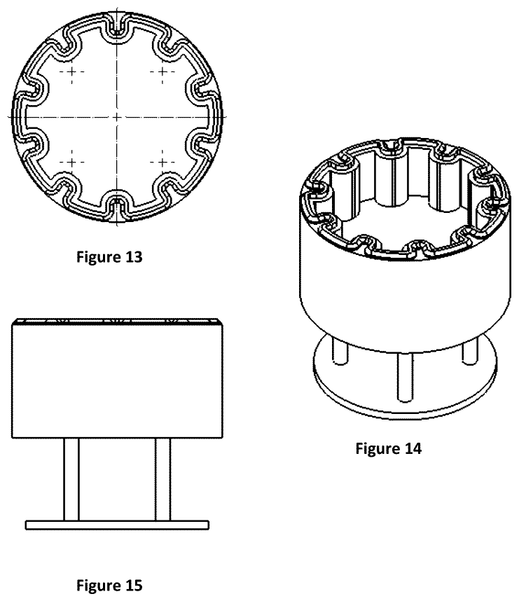

Referring to FIGS. 7-8, we can see 700 the unit in operation. After placing a folding plastic sheet 502 on top of each work area, an operator places a clump of dough 708 (aka masa) into the selected initial work area. When a single operator is working, this many be the position in front of area 704 or 706. With two operators, the initial position is that shown as 706 (so that a second operator is removing finished empanadas from position 702 or 704.

The amount of dough is that slightly over the amount needed by the finished empanada, and of a height below that of the security guard 116 entry height. Once the dough 708 is placed, the turntable 102 is advance clockwise 710 (either through a motor, pneumatic or manual push by the operator) by a single position (702/704/708) advancement until the unit's brake stops it from further advancement. In operation, the finished empanada is lifted and replaced by the dough 708.

When the turntable 102 finishes advancing, the flattener 206 comes down and flattens the dough, pushing it down into a roughly spread empanada template (aka ‘plantilla’) of variable size and thickness determined by how long the piston comes out of the upper cylinder 114. Once the flattener 206 and mold 136 retract, the turntable 102 brake releases allowing for the operators to rotate (or alternatively the pneumatic/motor advances) the turntable 102.

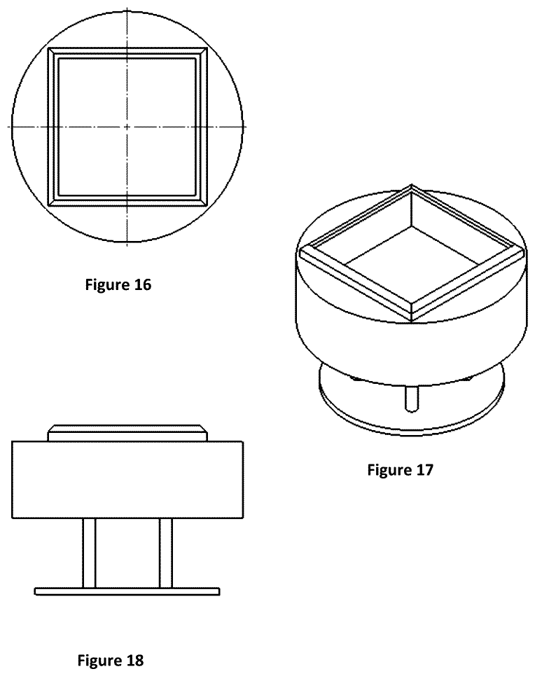

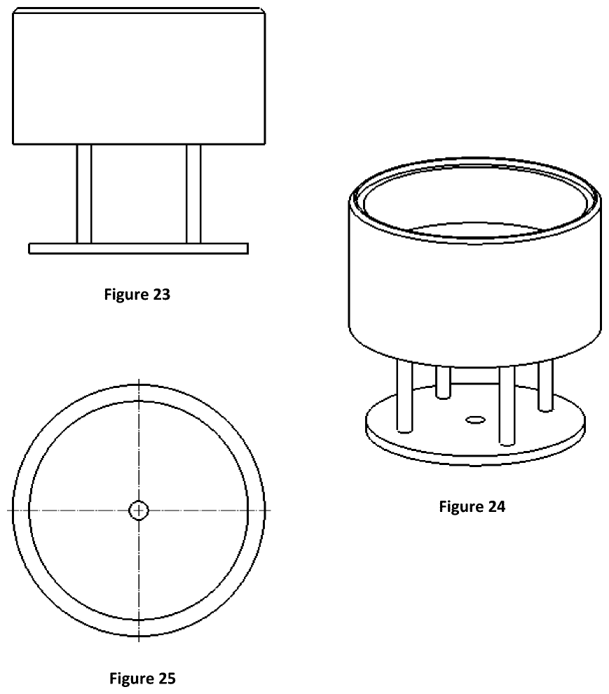

Once flattened, the turntable advances, placing the flattened template outside the safety area (delimited by the safety shield(s) 116), where an operator places the empanada filling within the template (at station 702) and folds the plastic sheet 502. Once the turntable 102 advances next, the mold 136 presses down 800 the plastic sheet 502. Based on the shape of the mold, the folded template is pressed into the surface, in effect cutting the empanada shape. Once the plastic sheet is opened, the empanada is extracted and the left-over template material is removed. The sheet 502 is unfolded and the cycle begins again. The mold's 136 internal volume is shaped as desired, including half-moon (traditional empanada shape) as well as others. In an alternate embodiment, two empanadas are made at the same time (side-by-side) using special molds (FIGS. 9, 11 and 13-25).

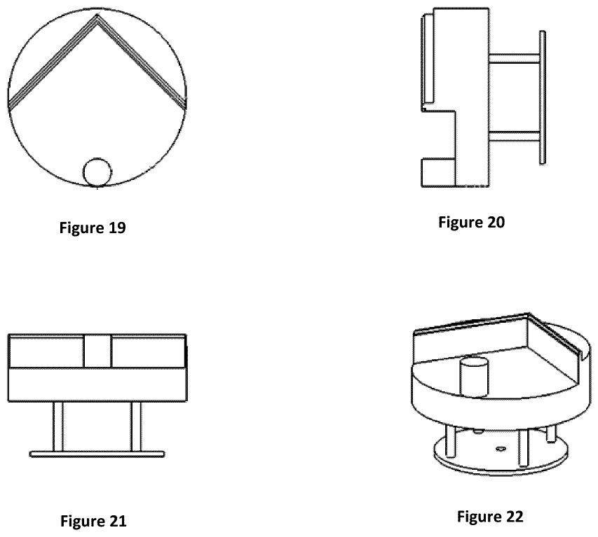

Referring to FIG. 12, we see details of the rotation fixation and/or activation mechanism 1200 for the turntable 102. Located between the bottom of the turntable 102 and the base 226, are two or more wheels 1206 in contact with the lower portion of the turntable 102 in order to support the weight and prevent any wobbling in rotation when the pressing components (flattener 206 and mold 136) are activated. When a motor or pneumatics are used to move the turntable, a simpler encoder or switch(es) on the rotating flange would be enough to know when the turntable 102 is in a position to activate the pressing components 206/136 or others.

But there is a cheaper and simpler embodiment that is envisioned. In this mode, a human provides the initial displacement of the turntable 102 to advance the work area 108 to the next stage (by rotating the turntable by hand 102), but the turntable is automatically stopped when one work area has been advanced. This could happen as above (encoder/switch on the flange) and a hook/pin or other insertion when the area has been advanced.

In another embodiment 1200 a displacement wheel 1202 in contact with the bottom of the turntable 102 goes into an opening 1204 located in the surface below the turntable 102. The wheel is kept pressed against the bottom via a spring 1208 and has a switch 1210 which opens/closes when the wheel 1202 displaces up/down (or vice-versa). The entry of the wheel 1202 into the opening 1204 both stops the turntable 102 and lets the control electronics know it is time to activate the pressing components 206/136 or others. In yet another embodiment, the wheel 1202 stops rotation and the operator activates the pressers 206/136 via activation of the button 130. Note that to rotate to the next position, the operator need only overcome the pressure of the spring 1208 by pushing for rotation and releasing once the turntable rotates freely.

### CONCLUSION

In concluding the detailed description, it should be noted that it would be obvious to those skilled in the art that many variations and modifications can be made to the shown embodiments without substantially departing from the principles of the present invention. Also, such variations and modifications are intended to be included herein within the scope of the present invention as set forth in the disclosure.

It should be emphasized that the above-described embodiments of the present invention, particularly any “exemplary embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention.

The present invention has been described in sufficient detail with a certain degree of particularity. The utilities thereof are appreciated by those skilled in the art. It is understood to those skilled in the art that the present disclosure of embodiments has been made by way of examples only and that numerous changes in the arrangement and combination of parts may be resorted without departing from the spirit and scope of the invention.

1. An empanada manufacturing system comprising;
a support surface housing a circular rotatable turntable, vertical and horizontal support structures, turntable rotation control components, flattener and mold pressing activation components, control electronics and one or more user interface buttons;
wherein said circular rotatable turntable has its surface area divided into at least four work areas, each said work area having a plastic sheet holder on its surface;
a flattening mechanism mounted on said horizontal support structure above said turntable, said flattening mechanism occupying an area corresponding to one said turntable work area;
a mold pressing mechanism mounted on said horizontal support structure above said turntable, said mold pressing mechanism occupying an area corresponding to one said turntable work area; and
automatic turntable rotation control components.

2. The system of claim 1 wherein;
said turntable automatic rotation control component is comprised of a turntable brake component that automatically stops said turntable after one said work area advancement;
electronic components allowing for the activation of the presser and the mold components after said work area advancement; and
said work area is covered by a foldable plastic sheet.

3. The system of claim 2 wherein;
said turntable brake component is comprised of a spring actuated wheel under said turntable;
said electronic components include an electronic switch coupled to said spring actuated wheel;
said turntable lower surface has a cavity complementary to said spring actuated wheel under each said work area;
said actuator for said presser is pneumatically activated; and
said actuator for said mold is pneumatically activated.

4. The system of claim 3 wherein;
said presser is covered by a plastic cap.

5. An empanada manufacturing method comprising;
providing a support surface housing a circular rotatable turntable, vertical and horizontal support structures, turntable rotation control components, flattener and mold pressing activation components, control electronics and one or more user interface buttons;
wherein said circular rotatable turntable has its surface area divided into at least four work areas, each said work area having a plastic sheet holder on its surface;
providing a flattening mechanism mounted on said horizontal support structure above said turntable, said flattening mechanism occupying an area corresponding to one said turntable work area;
providing a mold pressing mechanism mounted on said horizontal support structure above said turntable, said mold pressing mechanism occupying an area corresponding to one said turntable work area; and
providing automatic turntable rotation control components.

6. The method of claim 5 wherein;
said turntable automatic rotation control component is comprised of a turntable brake component that automatically stops said turntable after one said work area advancement;
electronic components allowing for the activation of the presser and the mold components after said work area advancement; and
said work area is covered by a foldable plastic sheet.

7. The method of claim 6 wherein;
said turntable brake component is comprised of a spring actuated wheel under said turntable;
said electronic components include an electronic switch coupled to said spring actuated wheel;
said turntable lower surface has a cavity complementary to said spring actuated wheel under each said work area;
said actuator for said presser is pneumatically activated; and
said actuator for said mold is pneumatically activated.

8. The method of claim 7 wherein;
said presser is covered by a plastic cap.
